(19) United States
(12) Patent Application Publication
(10) Pub. No.: US 2007/0186150 A1
(43) Pub. Date: Aug. 9, 2007

(54) Web-based client-local environment for structured interaction with a form

(75) Inventors: Sanjay Rao, Seattle, WA (US); Catherine McDole Rao, Seattle, WA (US); Shanti R. Rao, Altadena, CA (US); Potluri M. Rao, Seattle, WA (US)

Correspondence Address: LAW OFFICES OF RONALD M ANDERSON, 600 108TH AVE, NE, SUITE 507, BELLEVUE, WA, 98004, US

(73) Assignee: Raosoft, Inc., Seattle, WA (US)

(21) Appl. No.: 11/347,733

(22) Filed: Feb. 3, 2006

(51) Int. Cl. G06F 17/00; G06F 3/048

(52) U.S. Cl. 715/506; 715/505; 715/764

(57) ABSTRACT

A local runtime environment is loaded within a conventional web browser program and employed for generating a form based upon a definition that uses JavaScript or another data structure reversibly transformable into and out of JavaScript. The form can contain many pages, is generated locally, and its user interaction is handled by the local runtime environment without requiring interaction with a remote server from which the definition of the form may originally have been downloaded. The local runtime environment facilitates input and other user interaction with the form and executes any included functions. An almost unlimited variety of functions can be performed locally in connection with the form. Data that are input by a user can be saved locally or on a remote server. Optionally, an authorized user can enter a designer mode to make changes in the appearance and functionality of the form within the browser program display.

### BACKGROUND

In a typical web-based interaction with forms downloaded from a database accessed over the Internet (or other network), a user runs a browser program such as Microsoft Corporation's Internet Explorer™, Mozilla's Firefox™, or AOL's Netscape™ on a client computer. A request for the form to be downloaded is sent to the server. In response to the request, the server typically opens a data store and accesses the form as a hypertext or code listing in a format suitable to be displayed in a browser program. The server thus obtains the requested form in preformatted web page format that is compatible for immediate display by most browser programs. The server sends the web page form to the client computer for rendering in the browser display.

The client then interacts with the form by providing input. The input by the user is typically immediately transferred to the server. Any validation or computation involving the input by the user is carried out on the server—not on the client computing device and not within the browser program.

A substantial disadvantage of this conventional approach is the static nature of the web page form that is downloaded to the client by the server and the use of the server for executing all functionality incorporated in the web page that is dependent upon the user input. Also, the client computing device does not dynamically generate a web page form, but instead, simply renders the form based upon the hypertext or code provided by the server, which is interpreted by the browser program to render each web page in the client display. This paradigm is based on the concept of a “dumb” client that participates only to the extent of: (a) requesting a web page form from a server; (b) rendering the predefined hypertext or code returned by the server, to display the form in a browser; and, (c) sending the input by the user to the server for use any carrying out in functionality or calculations that are based on the input.

To modify a conventional predefined form, an authorized user must download the predefined hypertext markup language (HTML) or other code used by the browser program to display the web page form, load the HTML or other code into a web page editing program, modify the HTML or other code in this editing program, and then store the modified code back on the server. The user can not directly edit the appearance and functionality, add or delete interactive elements, or make any changes to the predefined HTML or other code within the browser program.

Clearly, it would be preferable to make more efficient use of the client computing device for enabling interaction by a user with a form displayed by a browser program. It would be much more efficient for the client computing device to dynamically generate web page forms locally for display within a browser program. Such forms should be dynamically generated to enable an authorized user, working on the client, to readily modify the form locally within the browser environment, as necessary to meet specific needs of the user. Such a dynamically generated web page form should have a much broader range of functionality than a predefined static web page form that is simply downloaded from a server and for which all of the interaction by the client is directed back to the server for processing. Authorized users should also be able to selectively modify the content, appearance, and functionality of the web page form, by making changes within the browser program. Such an approach will provide a much expanded interactive paradigm, compared to the conventional approach for enabling users to provide input or other forms of interaction with a form handled by a remote server.

### SUMMARY

A method has been developed for providing a form that is generated locally by a local runtime environment for display within a browser program, to enable interaction by a user with the form. The method includes the step of enabling the user to download the local runtime environment and a definition for the form over a network from a remote storage. It should be understood that the local runtime environment is separate and distinct from an operating system under which the browser program is executed, and runs within the browser environment. Based upon the definition that has been downloaded, the form is generated within the local runtime environment and includes one or more interface elements with which the user can interact. The form is displayed within the browser program, enabling the user to interact with the one or more interface elements. Without requiring any interaction with a remote server, the user can interact with the form, for example, by making a selection within the form using an interface element, carrying out a function associated with the form as a result of interacting with an interface element, or entering data into the form in connection with an interface element, or by modifying the form.

The user is enabled to selectively enter a designer mode, which facilitates modifying the form. After entering the designer mode, the user can select an option to modify a content and/or an appearance of the form. In addition, in the designer mode, the user can modify the form by at least one of adding a new interface element comprising a control, a menu, or an input dialog, changing a size of an interface element in the form, changing a parameter affecting an appearance of one or more interface elements in the form, or associating a function with an interface element in the form.

The method further can include the step of retaining information concerning changes made to the form to modify the definition for the form. The information indicates any new interface elements that have been added to the form and any interface elements that have been deleted from the form, as well as modifications to any existing interface elements. The definition as modified can then be saved to remote or local storage with the changes made by the user, so that the changes made by the user are indicated when the definition of the form is next downloaded for use in again generating the form. Also, a user can specify whether a new field added to the form by the user is private to the user or public and available to others who download the definition of the form as modified by the user.

Optionally, the method can include the step of validating an identity of the user on a server coupled to the remote storage, to enable the user to download the definition for the form to which the user has been granted access rights.

It is contemplated that in some cases, the user will be enabled to select the definition of the form to be downloaded from a plurality of definitions of forms that are stored by a server in the remote storage. As another option, the user may be enabled to selectively download data over the network, from the remote site where the data are stored, for use with the form, for example, in filling in fields of the form.

Preferably, the definition of the form is downloaded from the remote site over the network in a format comprising a JavaScript listing, an extended markup language (XML) listing, or as a data structure that can undergo a reversible transformation into and out of a JavaScript listing. In this exemplary embodiment, the JavaScript run by the local runtime environment uses dynamic HTML (DHTML) for generating the form as displayed by the browser program, while the local runtime environment is implemented using JavaScript.

The method can further include the step of enabling the user to save the form after interacting with the form, by uploading a definition for the form and any data input by the user, to the remote storage, over the network.

One or more interface elements within the form can optionally include a control that is selectively actuatable by the user to initiate execution of a program module that carries out a function within the local runtime environment. An example of such a program module is described below.

Another aspect of this development is directed to a memory medium on which are stored machine instructions. When executed, the machine instructions are operative to carry out functions that are generally consistent with the steps of the method discussed above.

Yet another aspect of the present novel development is directed to a client system for providing a form that is generated by a local runtime environment for display within a browser program, for interaction by a user of the client system. The client system comprises a computing device and includes a display, a user input device, a network interface device for coupling the system in communication with a server at a remote site, over a network, a memory for storing machine instructions (some of which are used for executing the browser program), and a processor that is coupled to the display, the input device, the network interface, and the memory. The processor executes the machine instructions stored in the memory to carry out a plurality of functions that are generally consistent with the steps of the method discussed above.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is a schematic block diagram of a generally conventional computing device that is suitable for use as a client computing device, as well as a server computing device, for carrying out the novel approach disclosed herein;

FIG. 2 is a schematic block diagram illustrating the communication of a client computing device with a server computing device, as discussed below, for enabling the client computing device to download a definition and local runtime environment software, for implementing the novel approach described below;

FIG. 3 is an exemplary web page survey form created and displayed in a browser window using the present novel approach;

FIG. 4 is an exemplary web page illustrating a dialog box opened for display in the browser program by the local runtime environment, to enable a user to selectively edit page controls for the survey form;

FIG. 5 is an exemplary web page opened in a browser program window by the local runtime environment to enable a user to specify parameters of the survey form;

FIG. 6 is an exemplary web page opened in a browser window by the local runtime environment to enable a user to select control options for use in the survey form;

FIG. 7 is an exemplary display of available pages provided by the local runtime environment in a browser program window, to enable a user to select a specific page of the form, for reviewing or editing the selected page within the browser program, under control of the local runtime environment;

FIG. 8 illustrates different input options for a page in an exemplary survey form displayed in a browser program window, using the local runtime environment;

FIG. 9 is an example showing how radio buttons can be selectively associated with a fieldname in a page of an exemplary survey form that is displayed in a browser program window using the local runtime environment;

FIG. 10 is an exemplary page displayed in a browser window by the local runtime environment, showing the steps implemented for saving a project;

FIG. 11 illustrates an exemplary calculator displayed within a browser program window of a form, in accord with the present novel approach;

FIG. 12 is a portion of an exemplary definition file listing used by a local runtime environment to generate a form displayed within a browser program;

FIG. 13 is a flowchart illustrating exemplary steps for interacting with pages of a form within a browser program, using the local runtime environment;

FIG. 14 is a flowchart illustrating exemplary steps that are implemented when a user has selectively entered a designer mode to modify one or more pages of a form within a browser program, using the local runtime environment;

FIG. 15 is a flowchart illustrating exemplary steps for saving data that have been entered by a user within a form displayed in a browser program, under control of the local runtime environment;

FIG. 16 is a flowchart illustrating exemplary steps for initializing display of a form within a browser program using the local runtime environment program; and

FIG. 17 is a flowchart illustrating exemplary logical steps for drawing a new screen for the page of a form within a browser program window, for example, in response to input provided by a user.

### DESCRIPTION

Figures and Disclosed Embodiments Are Not Limiting

Exemplary embodiments are illustrated in referenced Figures of the drawings. It is intended that the embodiments and Figures disclosed herein are to be considered illustrative rather than restrictive.

Computing System for Implementing Either Server or Client Functions

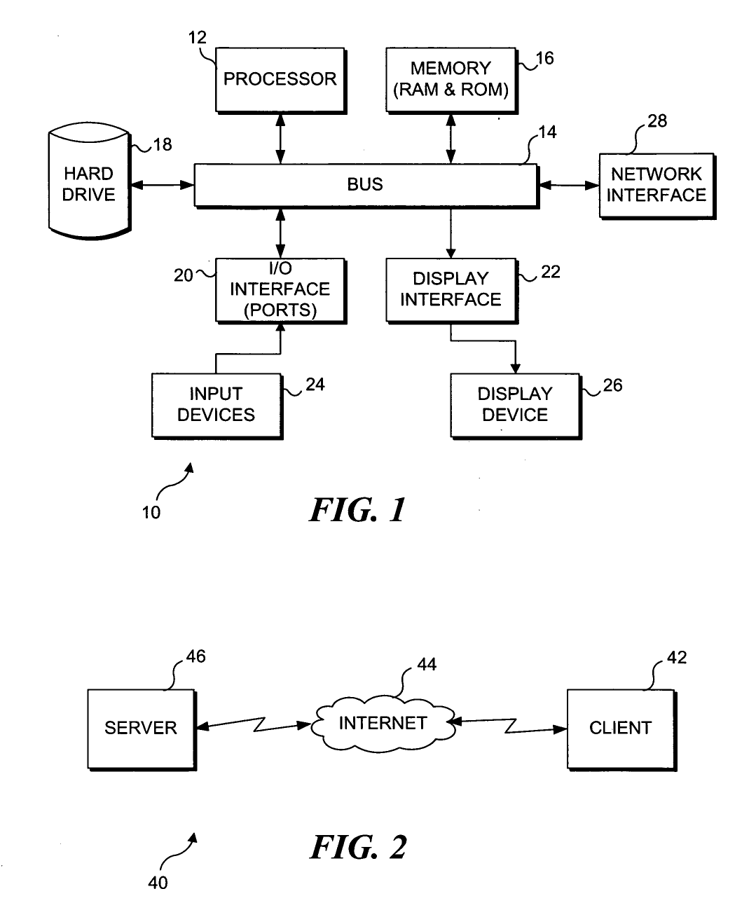

FIG. 1 illustrates an exemplary computing system 10 that is suitable for implementing the present novel approach for handling input and changes to forms. Computing system 10 includes a processor 12 that is coupled in communication with a generally conventional data bus 14. Also coupled to the data bus is a memory 16 that includes both random access memory (RAM) and read only memory (ROM), which are not separately shown. Machine instructions are loaded into memory 16 from storage on a hard drive 18 or from other suitable non-volatile memory, such as an optical compact disk-read only memory (CD-ROM) or other type of optical or magnetic medium. These machine instructions, when executed by processor 12, can carry out a plurality of different functions, including those disclosed in connection with the present novel approach for completing and/or modifying forms within the display window of a browser program.

An input/output (I/O) interface 20 that can include one or more of a plurality of different types of ports, such as serial (RS-232), parallel, universal serial bus (USB), PS/2, and Firewire (IEEE 1394) ports, is coupled to data bus 14 and is in turn connected to one or more input devices 24, such as a keyboard, mouse or other pointing device, enabling a user to interact with the computing system and to provide input and control the operation of the computing system. For example, on a client computing system, the keyboard and mouse can be employed by a user to control and/or provide input to a browser program. In this case, a local runtime environment that is instantiated and executed within the browser program handles interaction (e.g., input control selection, or text input) by a user with a form being displayed by the browser program, and/or enables an authorized user to edit the form within a window displayed by the browser program. A display interface 22 couples a display device 26 to the data bus, enabling, for example, the browser program window, forms, and other graphic and text information to be displayed for viewing by a user on a client computing system. The computing system is coupled to a network and/or to the Internet via a network interface 28, which couples to data bus 14.

It will be apparent that the hardware components of computing system 10 that is discussed above can also be employed for providing the functions of a server that is accessed over a network or via the Internet. For example, such a server can be accessed to download scripts, definition files for forms, and optionally, data used to fill-in fields of a form, for use with the present approach. Details of the server functionality and interaction with a client computing system are explained below.

FIG. 2 illustrates a simplified functional block diagram 40 illustrating how a client computing device 42 that is executing a browser program uses the browser program to connect and communicate with a server 46 over Internet 44 (or over some other form of network) to enable a user to select a definition file to be downloaded for use in generating and displaying a form within a window of the browser program, on the client computing device. A definition file for a selected form is downloaded by the server to the client computing device. If the client computing device has not previously downloaded a file that includes the code for executing a local runtime environment within a browser program, from this or another server, the server can automatically determine that the client computing device needs the local runtime environment code file and download that file with the definition file for the form. The local runtime environment code is designed to be installed and executed within the browser program. When thus installed, the local runtime environment enables a form (i.e., a web page form) to be generated for display within a window of the browser program, based on the definition file for the form. Also, the local runtime enables changes to be made to the appearance of a form within the browser program display, by an authorized user, as explained below.

Contrast with Conventional Approach for Handling User Interaction with Form

Unlike the conventional approach for handling forms that are opened in a browser window (which presumes a “dumb client”), the present novel approach enables a client computing device to carry out most of the functional tasks that are associated with completing or otherwise using a form opened by a browser program being executed by the client computing device. This novel approach is in stark contrast with the conventional way in which forms displayed by a browser program enable interaction by a user. For example, when interacting with conventional online forms, a user downloads a predefined form from a web site and enters data or makes control selections where indicated in the form. The input provided by a user within the displayed form is immediately transmitted back to the server for validation, or to carry out other functions associated with the input or control choices provided by the user. Examples of such forms include surveys that are conducted over the Internet using the conventional approach discussed above.

A variety of many other applications employ forms for input of data within a browser window. As one example of an application of the conventional approach for completing a form, a business user might connect to a web page maintained by a state tax office to input data on one or more pages of a quarterly tax form that the user downloads from the web site, after signing on with a secure user name and password. Immediately after the user completes an input, for example, of gross revenue for the last quarter and advances to the next web page of the tax form, the values that were input by the user may be transmitted to the server for validation, or for use in calculations to determine a tax that is due. The client computing device that executes the browser program in which the predefined pages of the tax form are downloaded from the server and displayed does not carry out any of the validation or calculation functionality.

In contrast to the preceding example of the conventional approach, the present novel approach would employ the local runtime environment to enable the pages of the tax form to be generated for display within the browser program of the client computing device, and the local runtime environment executing within the browser program would be able to carry out a variety of different functions such as input validation and computations locally on the client computing device. The result of the validation and any such computations would then be displayed locally within the browser program window. At a predefined point in the process or as controlled by the user, only the data entered by the user and the results of the validation and any computations that were carried out, would be uploaded to the server for storage, thereby completing the filing of the tax information for the form with the state tax office.

Overview of the Present Novel Approach

In the present novel approach, a client initiates a session in a window of a browser program by opening an HTTP/HTTPS communication link with a server from which the user wants to download a definition file for a desired form. This step may involve providing a user name, password, or other appropriate user authentication information. Once connected to the web site at that location, after any required credentials have been provided, a menu may be displayed enabling the user to select one of a plurality of different forms, so that the definition parameters for the form are downloaded by the server to the client computing device of the user. The menu that is displayed by the server within the browser program of the user may require further authentication to be provided to access a database of such form definition files maintained by the server.

When the selection of a form is made, the browser program may send information maintained in a cookie on the client computing device that indicates whether the client computing device already has the code for the local runtime environment that is used to generate a form and enable interaction by a user with the form within the browser program. If the browser program does not indicate that the user already has downloaded the local runtime environment from this or a different server, when the definition file is downloaded from the server, JavaScript for executing the local runtime environment will also be downloaded to the browser program of the user. Alternatively, the JavaScript for the local runtime environment may be downloaded upon a first connection to the server, initially bypassing the menu until this step is completed. Once loaded into the browser program (or into some other computer language interpreter), the local runtime environment can enable a form definition file to be downloaded from a database of such form definitions maintained by the server.

In this exemplary embodiment, the definition for a form that is downloaded is either in JavaScript or is provided as a data structure that can undergo a reversible transformation into and out of JavaScript. Using this definition, the local runtime environment produces interface elements that are displayed on a web page in a window of the browser program. Using dynamic HTML (DHTML), the local runtime environment thus generates the form for display as one or more web pages within the window of the browser program.

Optionally, a user may selectively download data from a database maintained by the server for use with the form. The client computing device can then parse the data that are downloaded and fill-in one or more fields within the form with appropriate information included within the data. Again, the client computing device is using the local runtime environment for parsing the data and for carrying out all of the functions performed with the data in connection with completing the form.

A user can interact with the form, for example, by altering, adding, or removing field values. The local runtime environment can perform validation of the user interaction or input, based upon validation rules that were included in the definition file for the form. In addition, the local runtime environment can execute programs or functions that are embedded within the form, for example, based upon user input in a pop up dialog, or in response to conditions set forth in the definition of the form, or as a result of selections made by the user in the displayed form.

A program embedded in a form may request the local runtime environment to perform a function, such as displaying a dialog box for picking a color. To facilitate such functionality, the local runtime environment can fetch the required code, which can be in JavaScript or in some other program language, from the server (if not already included in the definition file) and cache the code locally for future use, before executing the code. The local runtime environment may later use this cached code without contacting the server again. This secondary function (e.g., color dialog) may act as a second instance of the form, passing completed data to the primary instance or to a remote server. As a user moves from page to page of a multiple page form, interface elements within the form can be shown, hidden, created, or destroyed, as field data are synchronized with a cache of data retrieved from the server. If multiple tuples are required in connection with the data, scripting language objects, indexed with an array or hash table, can be employed within the form. Even moving from page to page within a form can be subject to validation rules, which may be set via property pages when the form was opened in a designer mode, or when the form was originally created as a definition file, e.g., using a blank template for the form. For example, changing pages in the form may trigger events that run JavaScript code. This code can be edited while the form is opened in the designer mode, as further discussed below.

Designer Mode

Using the local runtime environment, the client computing device has the ability to edit every property of each interface element in a form, according to the present approach. Assuming that a current user is authorized to do so, the user can enter the designer mode to make such changes to a form. The designer mode can be entered, for example, by making a selection in the menu bar, clicking with a mouse on a specific control, or simply in response to the user connecting to the server from which the definition for the form is downloaded, using credentials that authorize the user to edit the form in the designer mode when it is opened for display in the window of the browser program.

After entering the designer mode, the local runtime environment intercepts keyboard and mouse events that would otherwise have been sent to the form. Thus, a user can click on any interface element to drag-and-drop or resize it with the mouse, just as in a desktop publishing program. When the user clicks on an interface element with a mouse, or selects it from a list, a property page for the selected interface element appears, for example, as a pop up dialog, an IFRAME, or a draggable DIV (division tag) in the same window. In this exemplary embodiment, the property page uses the JavaScript variable system to apply any changes made by the user within the property page immediately back to the display of the form page within a window of the browser program.

When either the user or the local runtime environment determines that it is time to save data entered into the form or changed in regard to its definition, the local runtime environment packages its cache of the database data into a format that the server expects, such as tab delimited data, MIME, XML, or some other appropriate data format. Optionally, the local runtime environment may provide for electronically signing the data with credentials corresponding to the cache before sending the data to the server for storage or other use.

The local runtime environment may have more than one tuple, with one or more forms open at once. For transactional database updates, the data from all tuples within the data cache on the client computing device are preferably sent in the same server transaction and are assigned to a common transaction identifier by the server. A corresponding confirmation message should preferably be returned to the client computing device by the server.

When the local runtime environment submits a transaction to a server, it may receive an error case indicating that the transaction did not complete successfully. In the event of such a failure, the local runtime environment may present an error message, giving the user an opportunity to re-attempt the transaction, possibly with modifications directed to ensuring success. The definition file for a form that is initially downloaded by the server to the client computing device is in a format that the local runtime environment can parse, for example, structured JavaScript code, XML, etc., to enable the local runtime environment to use the definition file to generate a list of JavaScript objects that map to interface elements within the form. If a field is added to a form while the user is working within the designer mode, the user will have an option to determine if the field is to be public, or private. The modified definition file for the form can then be stored on the server. This information regarding the public/private nature of any added field can then be used by the server when the definition for the form is subsequently requested to be downloaded.

As changes are made to the appearance of the form in the designer mode, the list of changes maintained by the server is modified and a function is called to re-render the list as interface elements. The user can modify interface elements and then only create or destroy them as necessary. The local runtime environment also provides a function to render this object list into the same format in which the server originally sent it at the beginning of a session. Optionally, other formats that contain sufficient information to reproduce the original format of the form can alternatively be used for this purpose.

Exemplary Multiple Page Survey Form

While it should be apparent that the novel approach described herein can be employed for an almost unlimited variety of forms, the following discussion is directed to an example in which a survey form having multiple pages is generated by a local runtime environment for display within the window of a browser program. These pages are generated based upon a definition file that would likely have been downloaded from a server, unless already stored on the client computing device being employed by a user to complete the survey by entering data into the pages of the survey form.

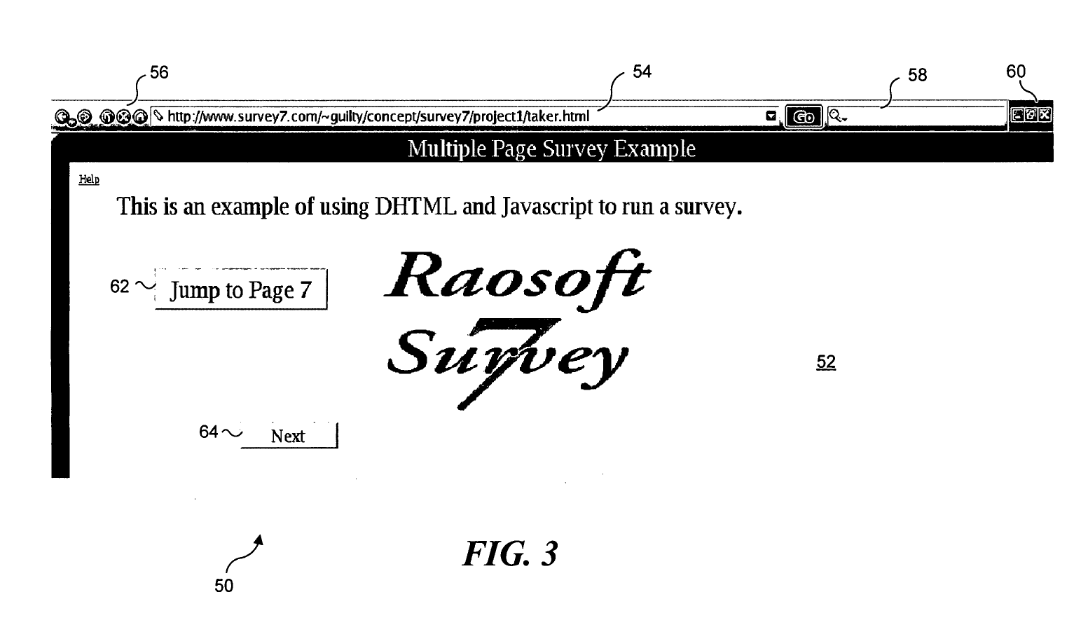

FIG. 3 illustrates a portion of a browser window 50 in which a page 52 of the survey form is displayed. In this example, page 52 displays a URL for the page in an address box 54. The definition file for the form uses JavaScript to enable the local runtime environment to generate this page within a window of the browser program for display to the user. Typical browser controls 56 are included at the top of the browser window, as well as a search dialog entry box 58 and operating system window controls 60, controlling the browser window size (or closing it). On page 52 are included at least two interactive elements that can be selected by the user to carry out an indicated action or function. For example, a control 62 can be selected by the user to jump from the current page, to a page 7 within the survey form. Alternatively, the user can select a control 64 to advance to the next page of the survey form. It must be emphasized, that the response to a user selecting either control 62 or control 64 is carried out only within the local runtime environment, and need not require transmitting a request for HTML used to display a different page to be downloaded from the server. Instead, the definition file that was previously downloaded for this form can be used for generating each of the pages of the survey form for display in the window of the browser program with the local runtime environment, when the pages are required to be displayed.

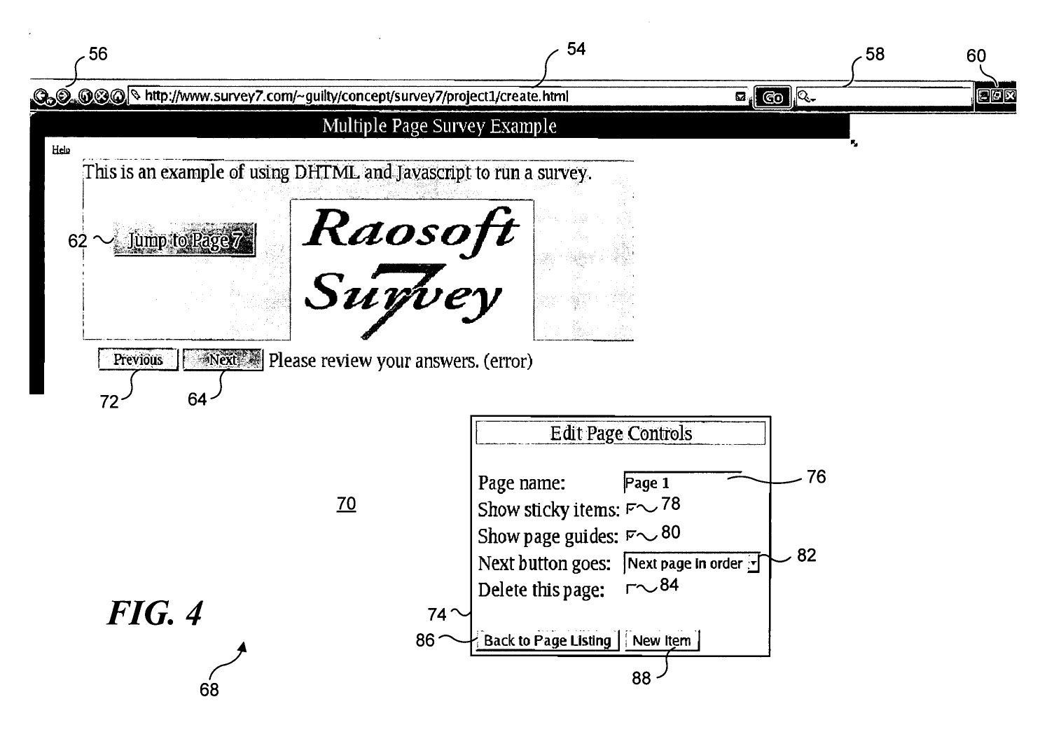

FIG. 4 illustrates an exemplary page 70 as displayed within a browser window 68. The same elements of the browser program, including address box 54, browser controls 56, and operating system window controls 60 are provided in this and most of the other browser windows discussed below. Also shown in this example is a control 72, which can be selected to enable the user to return to a previous page. While on page 70, the user has entered the designer mode, causing an edit page controls dialog box 74 to be displayed. Within edit page controls dialog box 74, a text entry box 76 is included to enable the user to input a page name for the current page. Checkboxes 78 and 80 are provided to enable the user to selectively determine whether to show “sticky items,” and page guides. “Sticky items” are form objects, such as repeated page banners, which may be shared among multiple pages. “Page guides” are visual indicators, such as on-screen rulers, to help positioning only while designing. A drop-down list box 82 is included so that the user can determine the response that will be applied if a user selects control 64, which is labeled “Next.” Optionally, the user can selectively delete the current page by selecting a checkbox 84. A control 86 can be selected to exit the designer mode and return to the page listing, while a new item (e.g., an interactive element) can be inserted into the page by selecting a control 88.

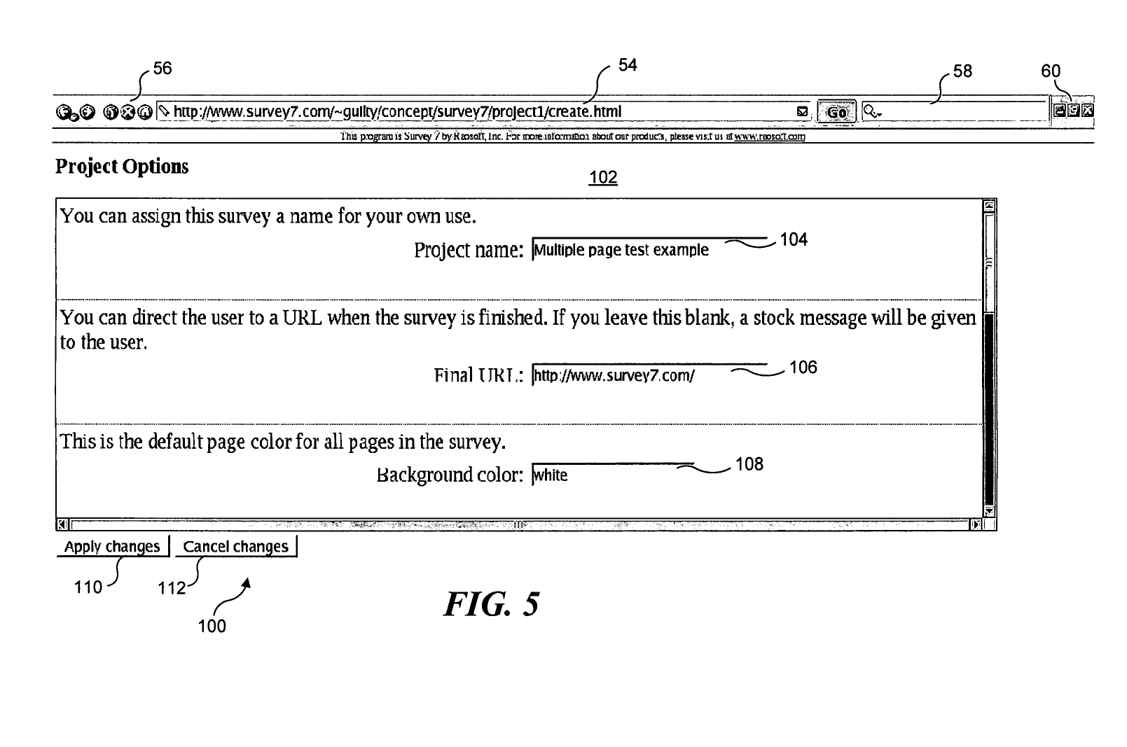

Other options available for the survey form are illustrated in a browser window 100 on a page 102, which is shown in FIG. 5. A text box 104 enables a user to assign a name for the survey project as desired. In a text box 106, the user can type a URL to which the user will be directed after completing the survey form. As indicated in the instructions, if text box 106 is left blank, a predefined or “Stock message” will be displayed to the user after the user completes the survey form. A text box 108 enables the user to specify the background color in designer mode that will be used as a default for each page in the survey form. By selecting a control 110, a user can apply the changes to the survey form, or alternatively, by selecting a control 112, can cancel all changes made on page 102. Any changes made to the form are carried out by the local runtime environment and can be either selectively saved by the user, or automatically saved in an asynchronous fashion, as discussed in greater detail below.

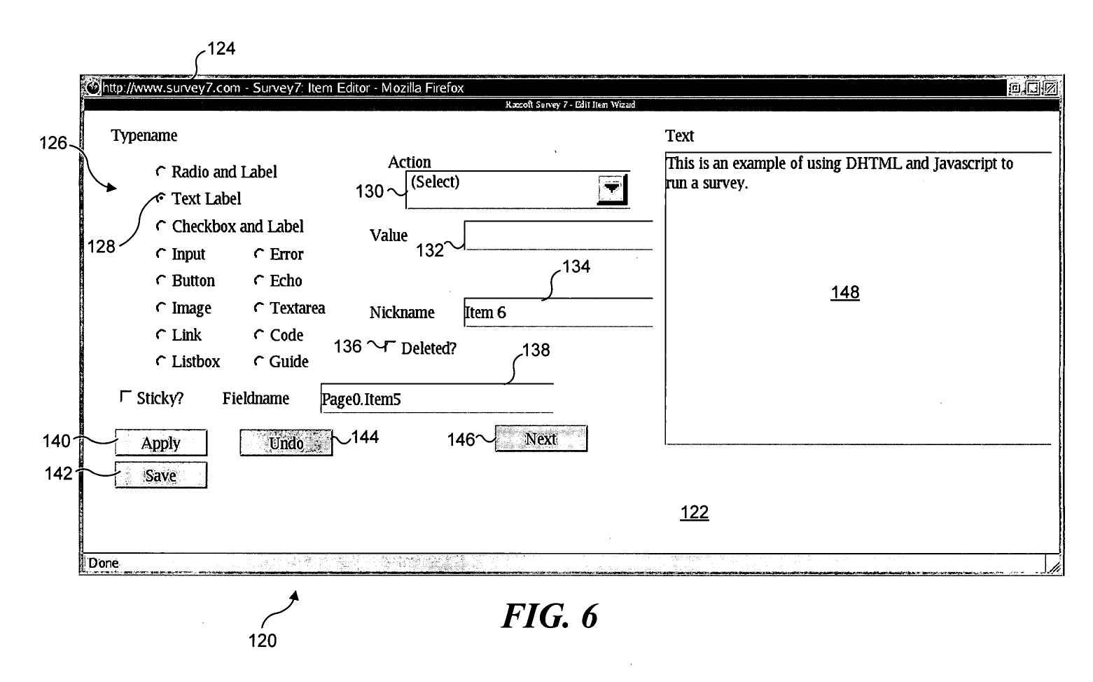

If in FIG. 4, the user selects control 88 to insert a new item, a page 122 is displayed in a browser window 120, as shown in FIG. 6. This browser window has a title box 124. In this example, a plurality of different radio buttons 126 are displayed for selection by the user, and in this example, a radio button 128 has been selected to indicate that the user wants to insert a text label on the form. A drop-down list box 130 is included to indicate the action that is to be associated with the user selecting the selected radio button. In addition, the user can assign a value to a parameter in a text box 132. Each interactive element that is included within a form can be associated with a nickname. A nickname for the selection radio button can be entered in a text box 134. Optionally, the user can delete a selected control by selecting a checkbox 136. If a field name is associated with the control, it can be entered in a text box 138. Controls 140, 142, and 144 respectively enable a user to apply the selected radio control and other input parameters, save the changes that have been made to the form, or undo any changes that have been made on this page. A control 146 enables the user to advance to the next page in the form, e.g., to make further changes. Text that are displayed in connection with the page being edited can be inserted within a text box 148. On the page being edited, the user can employ a pointing device, such as a mouse, to position, resize, or rearrange the interactive elements.

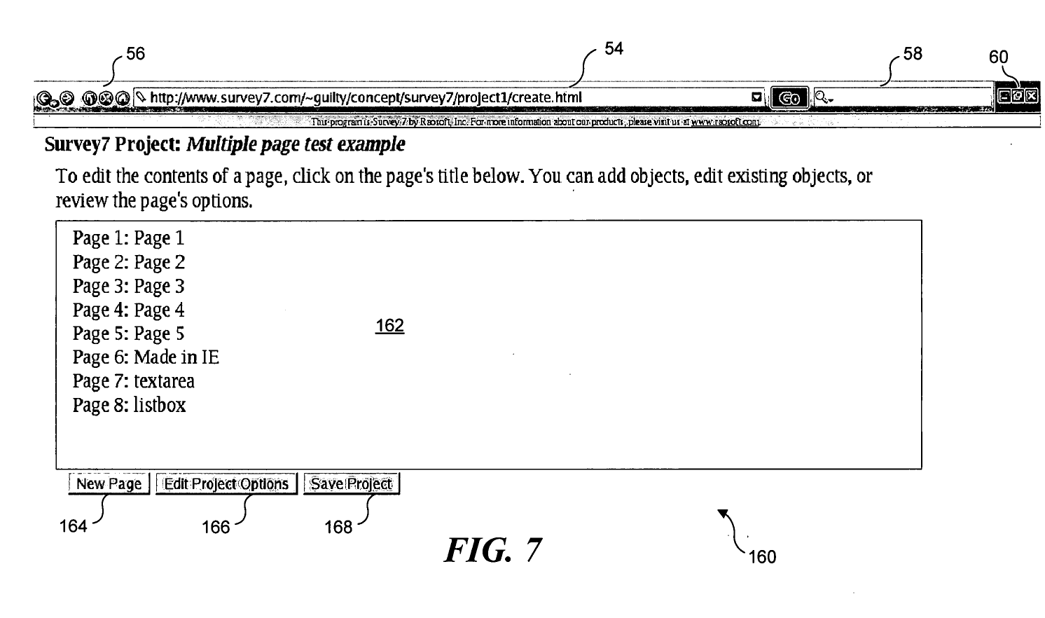

In a multiple page survey form, it will be convenient to enable the user to select one of the multiple pages in the form for editing from a list of pages. Accordingly, a page 162 in FIG. 7 illustrates an exemplary list displaying the available pages from which a user can select, within a browser window 160. The labels associated with each page are displayed by the page numbers. A user can simply double-click on one of the listed pages to open that page for editing. Alternatively, a control 164 enables a user to insert a new page within the form. Project options can be edited by selecting a control 166. Any changes made can be saved by selecting a control 168, which selectively saves the project in designer mode.

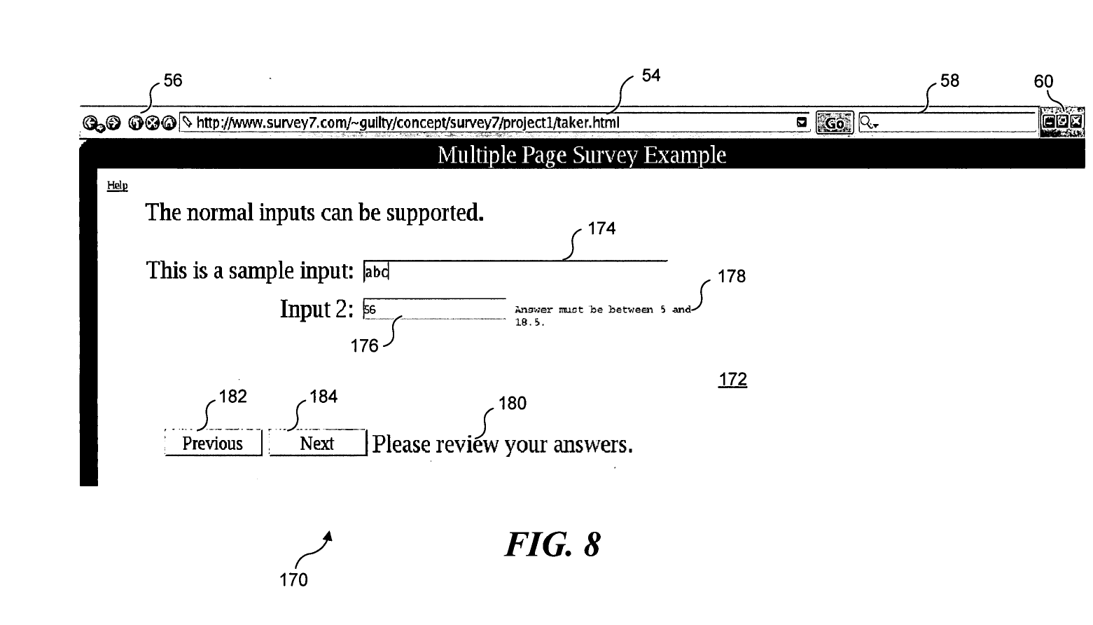

FIG. 8 shows a page 172 displayed in a browser window 170, illustrating how the exemplary survey form can readily accept a variety of different types of input from a user who is completing the survey. For example, a text box 174 enables the user completing the survey form to enter text input. The user might also enter a numeric value for a field of the form, as illustrated in a text box 176.

Again, it should be emphasized that the local runtime environment running on the client computer being used for entering text and other input to the survey form employs dynamic HTML and JavaScript for a variety of functions. One of those functions, for example, may be to apply predefined validation rules (i.e., rules included in the definition for the form) in regard to the numeric value entered in text box 176 by the user. In the example shown, the user has entered a value that is outside an acceptable range for that input text box and as result, the validation rule causes a message 178 to be displayed to the user indicating that the answer must be in the range between certain predefined values. Again, controls 182 and 184 enable the user to select a previous page of the survey form or to advance to the next page. Before selecting one of these options, the user is advised by a text message 180 to review answers entered within the current page.

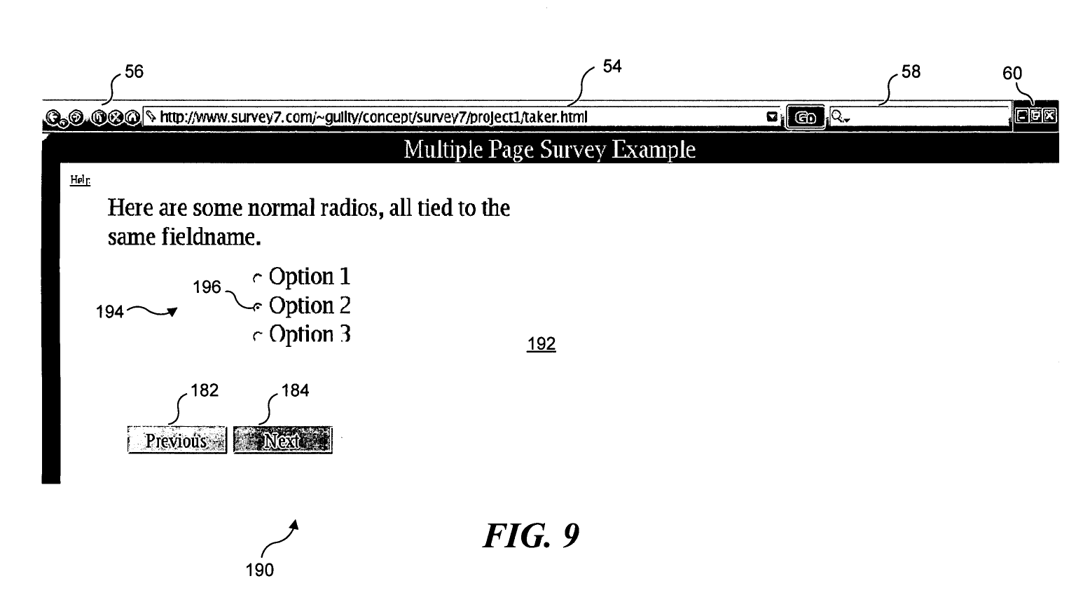

As noted in regard to FIG. 6, when operating in the designer mode, a user can enter a field name for an interactive element. FIG. 9 illustrates a browser window 190 displaying a plurality of radio buttons 194 on a page 192. As indicated in the Figure, each of the radio buttons shown for selecting one of three different options are all tied to, or associated with, the same field name. Thus, by selecting radio button 196, the user has selected an option in regard to the common field name. Controls 182 and 184 again enable the user to return to a previous page in the multiple page survey form, or alternatively, proceed to a next page.

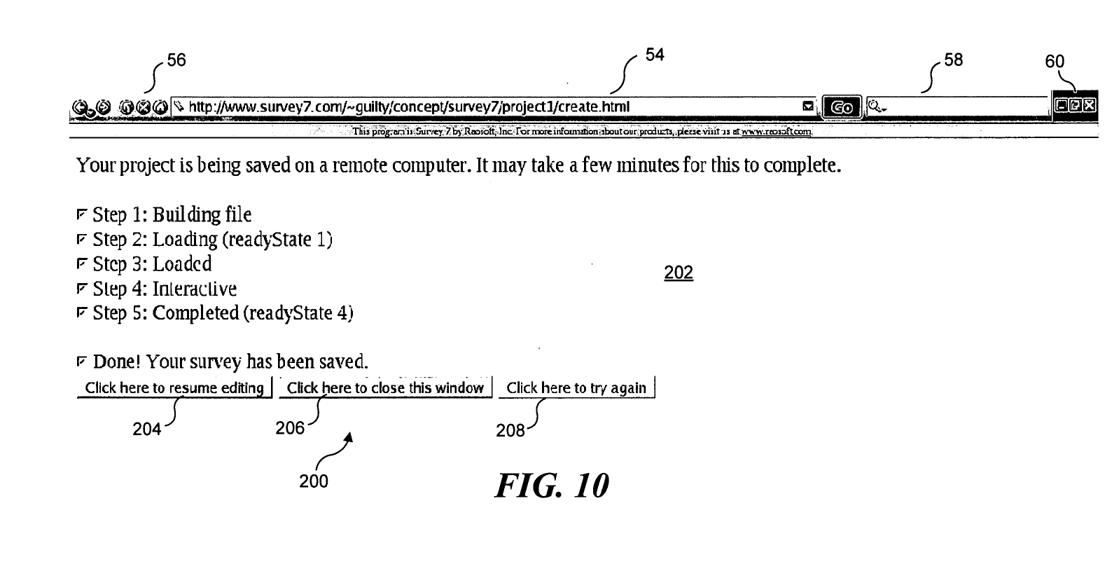

FIG. 10 illustrates a browser window 200 displaying a page 202 showing the steps that are implemented and then checked off when a definition file for a project is saved on a remote computer such as the server. Alternatively, the project could be saved on the client computing device, with the same steps indicated. As noted on page 202, the save procedure displays checks for the successive steps as it builds the definition file for the project, begins loading the definition file for transmission to the remote computing device, indicates when the definition file has been completely loaded, interacts with remote computing device to transmit the definition file for the project, and indicates that the transmission of the definition file to the remote computer has been completed. Finally, text is displayed on this page to indicate that the survey form project has been successfully saved on the remote computer. A control 204 indicates that the user has the option of selecting a control to resume editing. Alternatively, the user can select a control 206 to close the current window. In the event that the save process fails, the user can click on a control 208 to try saving the project again.

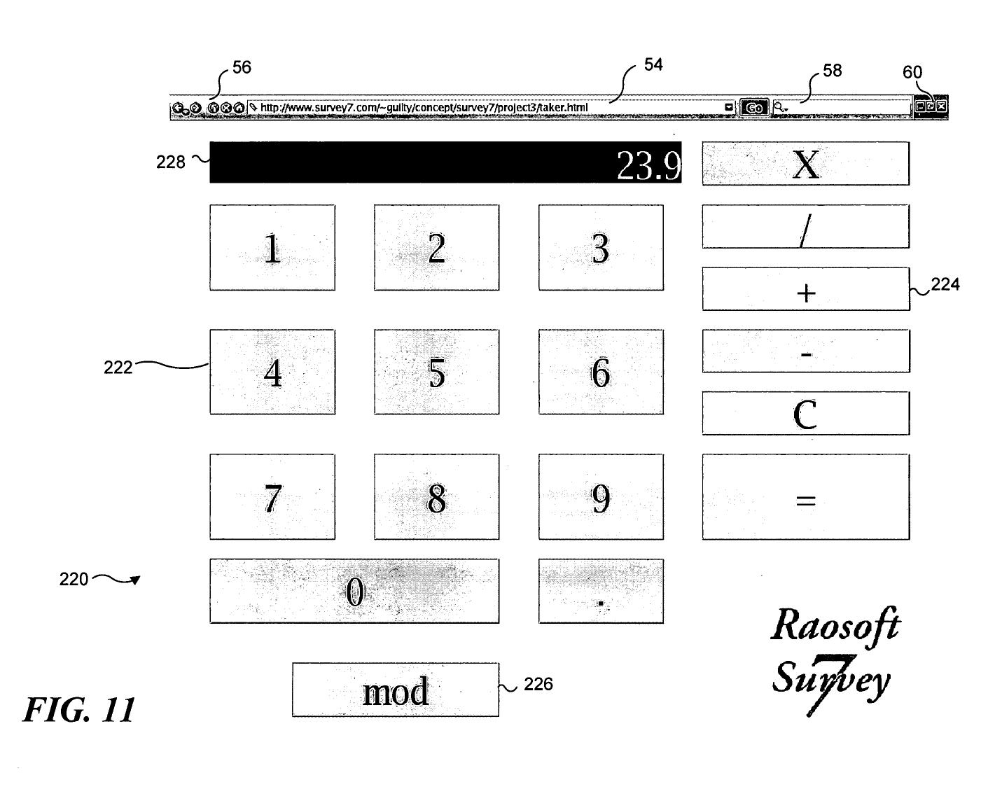

Although most forms include various types of graphic user interface input options, such as text boxes, drop-down list boxes, radio controls, checkboxes, etc., in addition to receiving input from a user, a form can also use the local runtime environment for executing many different types of functions. FIG. 11 illustrates a browser window 220 in which a calculator functionality is displayed to a user. The arithmetic calculations that are performed in regard to numeric values input on this calculator by a user are carried out by the local runtime environment. The calculator includes a numeric keypad 222, a set of mathematical operator controls 224, a mod function control 226, and a numeric value display 228, which is used to display input values as well as the result of a calculation. It must be emphasized that the calculator function is implemented by the local runtime environment within the browser program and does not use any external calculator program, such as a calculator that might be included with the operating system running on the computing device. Furthermore, it should be understood that the calculator function illustrated in this Figure is just one example, and that almost any type of function can be executed within the browser program, by the local runtime environment. Most such functions will be carried out without requiring communication with a remote server.

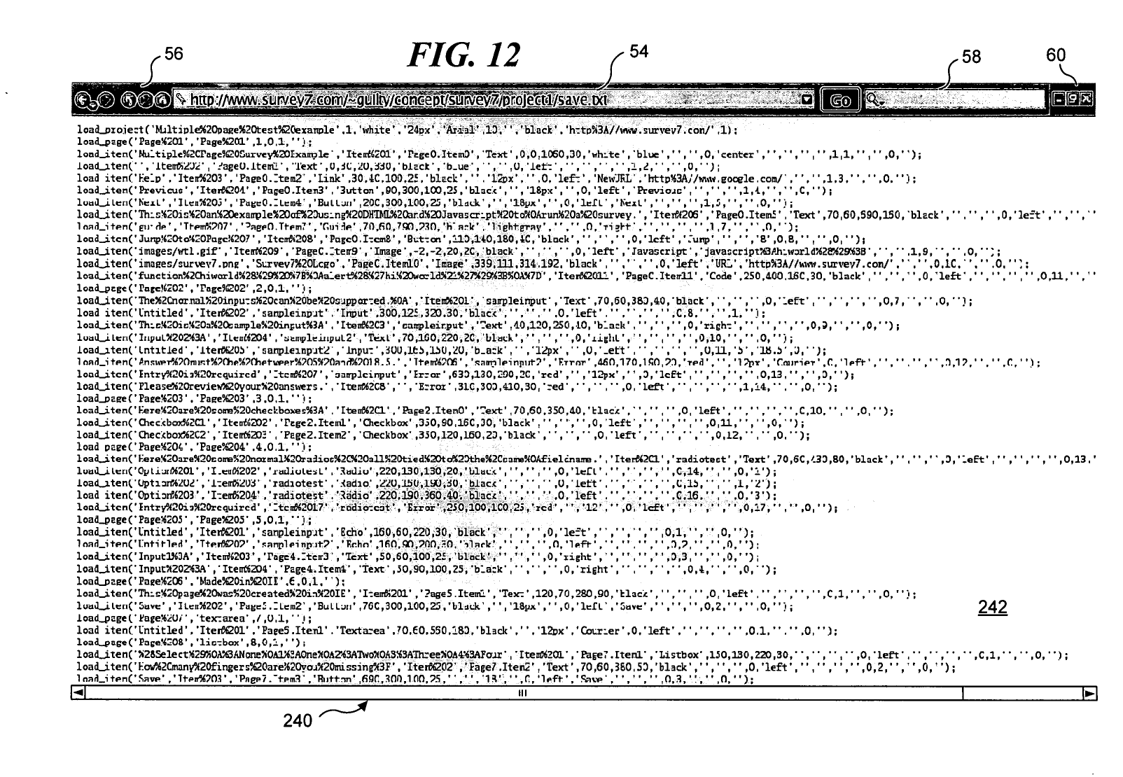

FIG. 12 illustrates a browser window 240 in which a listing 242 of JavaScript is provided as an example of a definition for a form that might be downloaded from a server for use by the local runtime environment for generating the form within a window of a browser program. Generally, JavaScript, or another data structure format, can be used for the definition so long as it is reversibly translatable into and out of JavaScript. It is important to understand that a conventional browser program would be unable to produce a form for display within the browser window based on the definition file. However, the local runtime environment is designed to use the definition provided in such a file for generating a form for display in the window of a browser program, and can carry out many different types of functions and enable an authorized user to edit the form within the browser program display.

Exemplary Flowcharts

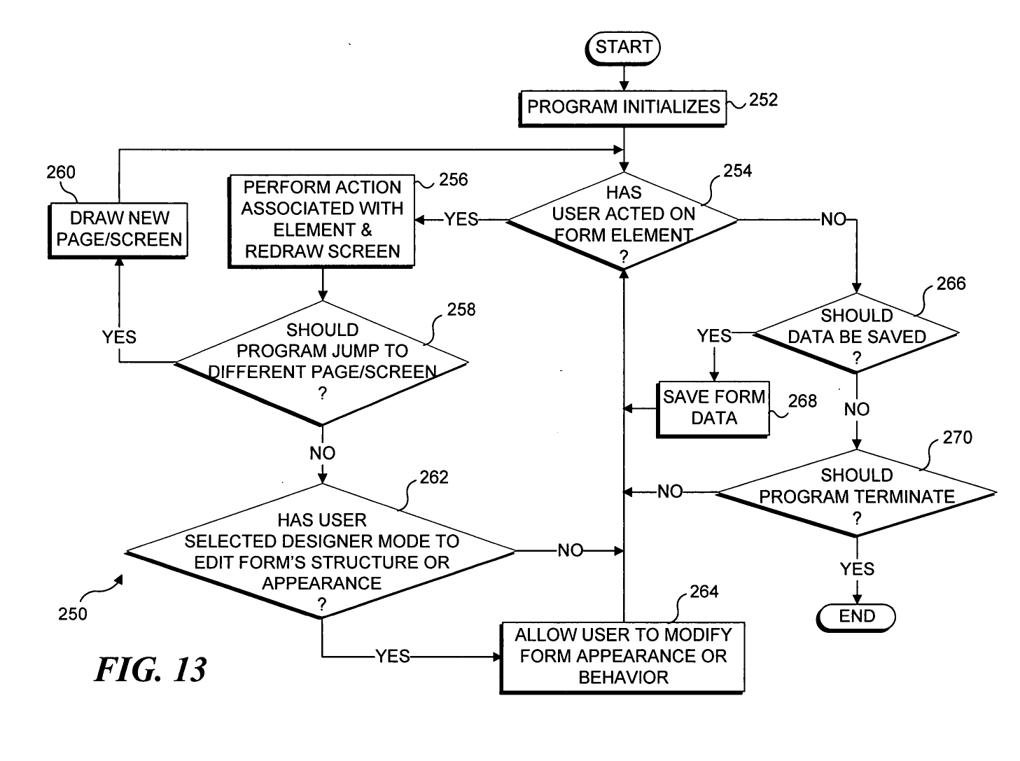

An overview of the logic performed in implementing the present novel approach is illustrated by a flow chart 250 in FIG. 13. A step 252 provides for initializing the local runtime environment within a browser program. Examples of suitable browser programs include Microsoft Corporation's Internet Explorer™, Mozilla's Firefox™, and AOL's Netscape™. In this step, the user can selectively download the definition file for a desired form to be displayed within the browser program, or simply open the definition for the form, if it is already saved on the user's computing device, so that the local runtime environment can generate the form and display it within the browser program. A decision step 254 then determines if the user has acted on an interactive element within the form. If so, a step 256 performs the action that is associated with the interactive element selected or acted upon by the user and (if appropriate) redraws the display screen for the browser program. A decision step 258 then determines if the code being executed by the local runtime environment requires a jump to a different page or screen within the form. If so, a step 260 draws the new page or screen within the browser program for display to the user. The logic then returns to decision step 254. If decision step 258 determines that there is no need to jump to a different page or screen, a decision step 262 determines if the user has selected the designer mode in order to edit the structure or appearance of the current form. If so, a step 264 enables a user (who has rights to do so) to selectively enter the designer mode, to modify the structure, appearance, or behavior of the form. The logic then returns to decision step 254.

A negative result in decision step 254 leads to a decision step 266 which determines if the data should be saved. The user can select an option to save the data, or alternatively, parameters within the design of the form can asynchronously automatically save either the input to the form (and/or changes to the design of the form), either locally or to the server, and at predetermined times, or in response to the data entry or changes made by a user. An affirmative response to decision step 266 leads to a step 268 wherein the form data are saved either locally or to the remote server. The logic thereafter returns to decision step 254. A negative response to decision step 266 leads to a decision step 270 which determines if the local runtime environment should terminate execution of the form within the browser program. If not, the logic again returns to decision step 254. Conversely, an affirmative response to decision step 270 causes the display of the form within the browser program to terminate.

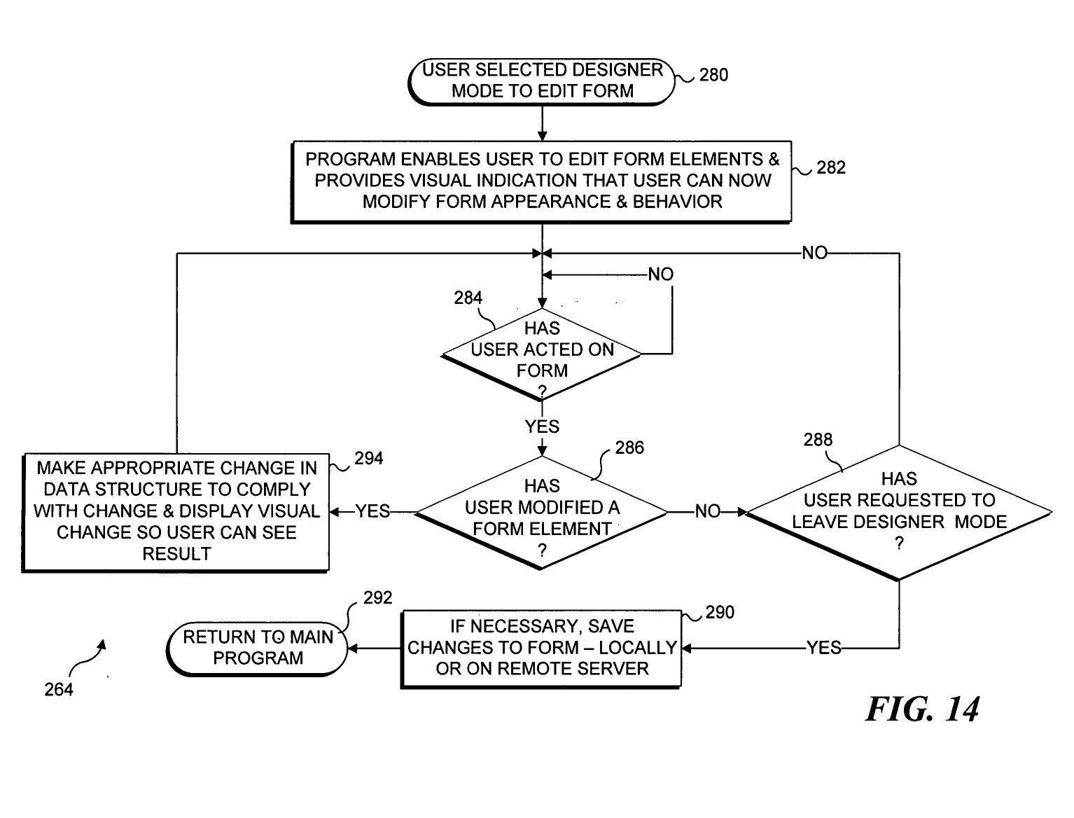

Referring now to FIG. 14, details of step 264 are illustrated. As indicated at a step 280, the user has selected the designer mode to enable the form to be edited. Clearly, it will be understood that step 280 will be permitted to occur only if the user has the right to edit the form in designer mode. If so, a step 282 provides that the local runtime environment enables the user to edit the form elements and displays a visual indication that the user can now modify the appearance and/or behavior of the form in the designer mode. A decision step 284 determines if the user has acted on the form in designer mode. If not, the logic awaits the user acting on the form. Conversely, if the user has done so, a decision step 286 determines if the user has modified an element of the form. The element being modified could relate to an appearance, adding or removing an interactive element, or a change in some other parameter relating to the way that the form operates or the functions that it performs. If no modification has been made to any form element, a decision step 288 determines if the user has requested or selected an option to leave the designer mode. If so, a step 290 saves any changes that were made to the form, either locally or on the remote server. The logic then returns to the main program, as indicated at a step 292.

An affirmative response to decision step 286 leads to a step 294, which makes an appropriate change in the data structure to comply with the modification to the form element made by the user. In addition, this step also makes a visual change, enabling the user to see the result of the modification. The logic then returns to decision step 284.

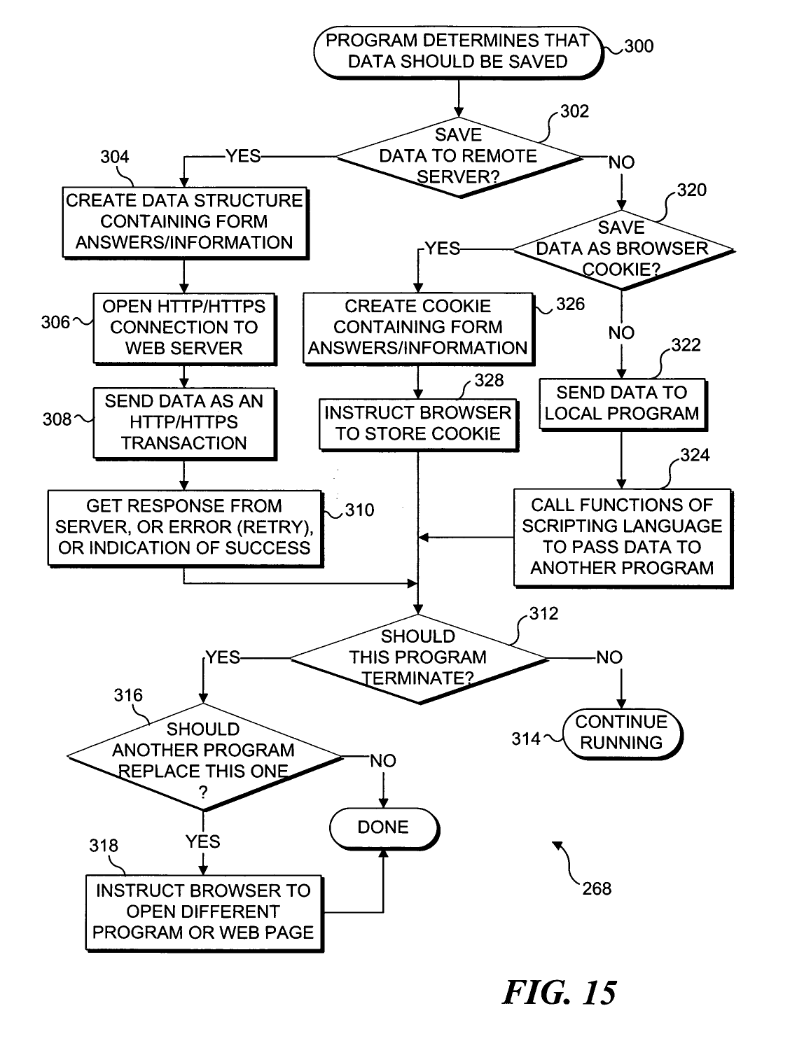

In FIG. 15, details of step 268 are illustrated. A step 300 indicates that the program (or user) has determined that the data should be saved. A decision step 302 determines if the data should be saved to a remote server. For some applications, or for certain types of user input, there will be no need to save the data to a remote server. A negative response to decision step 302 leads to a decision step 320, which determines if the data should be saved as a browser cookie. If not, the local runtime environment transfers the data to an external local program running on the computing device, enabling that local program to use the data as input. In connection with step 322, a step 324 calls functions of a scripting language to pass the data to the other program. The logic then proceeds with a decision step 312, which determines if the program should terminate. If not, a step 314 indicates that the local runtime environment continues running the current form for input or change.

An affirmative response to decision step 302 leads to a step 304, which provides for creating a data structure that contains the form answers or information entered by the user while interacting with the form. A step 306 then opens an HTTP or HTTPS connection to the web server where the data structure is to be transferred. Next, a step 308 sends the data to the web server as a transaction over the HTTP or HTTPS connection. In a step 310, a local runtime environment gets a response from the server. The response can be an indication of an error, causing the local runtime environment to retry sending the data, or an indication that the transaction with the remote web server was successful in transferring the data. It should be understood that the data being transferred might comprise a data structure identifying the fields in which input was provided by the user, as well as the input values for the fields. Following step 310, decision step 312 determines if the program should terminate. An affirmative response leads to a decision step 316, which determines if another program should replace the current running form within the browser window. If so, a step 318 instructs the browser program to open a different program or web page for display to the user. Following step 318 or a negative response to decision step 316, execution of the current form is completed.

An affirmative response to decision step 320 leads to a step 326, which creates a cookie containing the form answers or information that was entered by the user in completing the form. Next, a step 328 instructs the browser to store the cookie in an appropriate local storage for use within the browser program or in connection with the form at a later time. The logic then again proceeds to decision step 312.

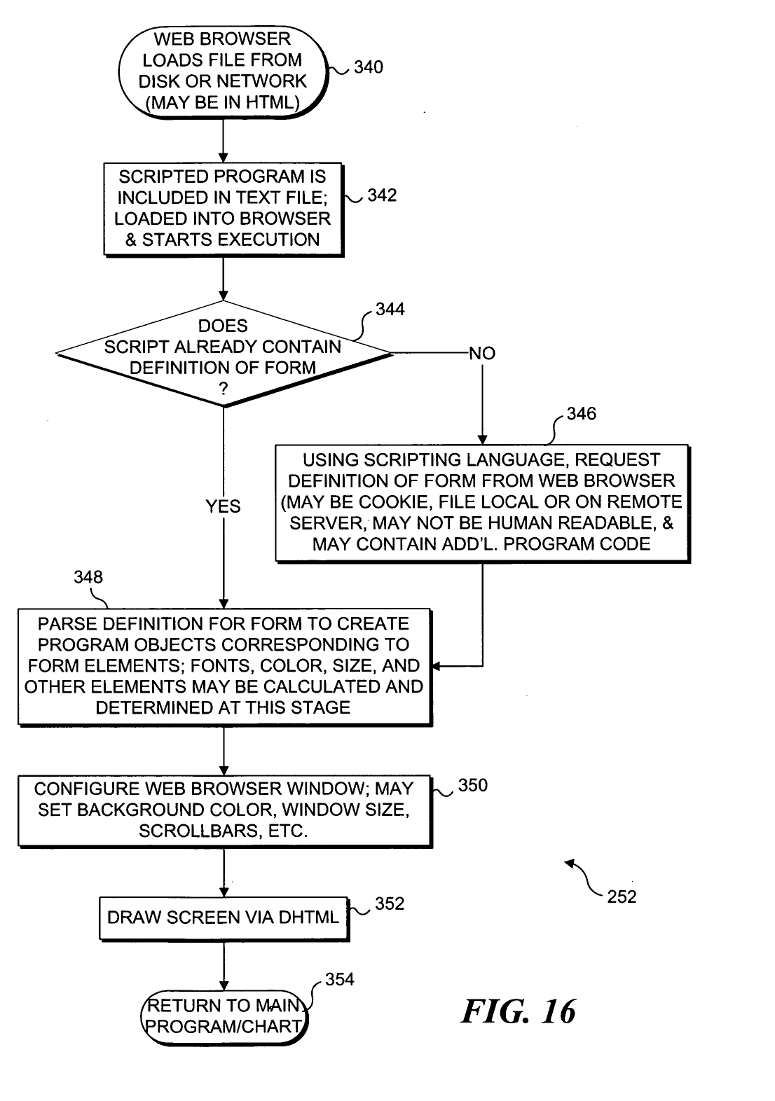

FIG. 16 illustrates details of step 252. As indicated in a step 340, when initializing the form creation program, the Web browser program loads a file from a local storage or from a remote location over a network. This file may be in HTML. In response to a selection made by the user within the displayed HTML document, the definition file for the form is downloaded. For example, the HTML may display a web page enabling a user to make a selection from a menu that lists a plurality of different forms to be downloaded. Alternatively, the web page that is displayed in the window of the browser program may include a control that if selected, simply downloads a definition file for a form. As indicated in a step 342, the downloaded definition is a script or program comprising a text file. The definition is loaded into the browser and executed within the local runtime environment. In some cases, the script that is downloaded or the text file that is obtained from the server or from the local storage may simply contain a link to the definition file for a form that is stored at a different location. Accordingly, a decision step 344 determines if the script already contains a form definition. If not, a step 346 uses scripting language to request a form description from the Web browser. The form description could be in the form of a cookie, a local file, or a definition file that is stored on a remote server. This file may contain additional program code for carrying out a plurality of other functions in addition to simply displaying one or more pages of the form within the window of the browser program.

Following an affirmative response to decision step 344 or after step 346 is executed, a step 348 parses the form definition to create program objects corresponding to interactive elements. In addition, fonts, colors, sizes, and other aspects or parameters of the page(s) or interactive elements may be determined or calculated at this stage. In a step 350, the local runtime environment configures the Web browser window based upon the definition for the form. During this step, the local runtime environment may set the background color, window size, selectively display scrollbars, and carry out other defined aspects needed to display the form as defined by the definition file, and as determined by the user who originally created, or edited, the design of the form in designer mode. A step 352 then draws the form within a screen using DHTML. Finally, in a step 354, the logic returns to the main program or flowchart, which is shown in FIG. 13.

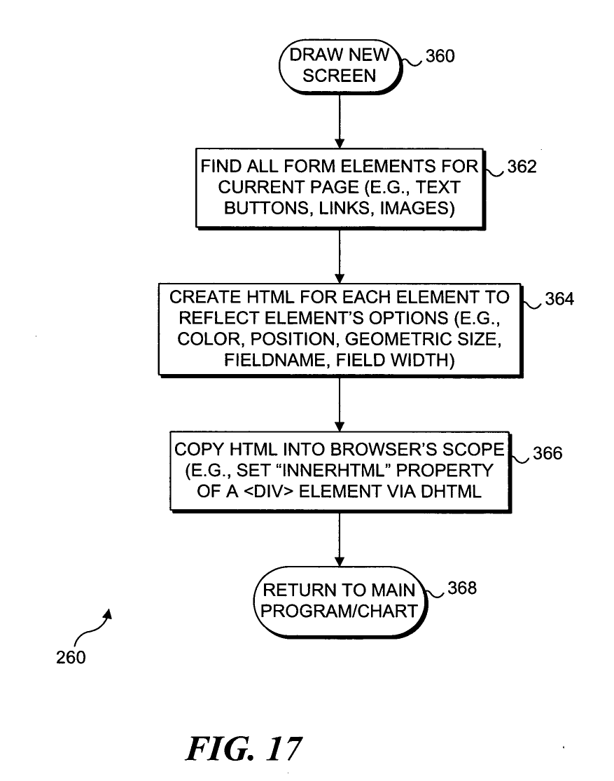

Details of step 260 are illustrated in FIG. 17. In a step 360, logic for drawing a new screen is initiated. A step 362 finds all form elements for the current page that is to be drawn as a new screen. Included within these form elements may be text buttons, links, images, controls, etc. A step 364 creates the HTML for each element, reflecting options that are defined for the element. For example, color, position, geometric size, field name, field width, and other variables associated with each interactive element are applied as appropriate to control the appearance and functionality of the interactive element to be displayed on the new screen. A step 366 then copies the HTML into the scope of the browser program. For example, this step can set the “innerHTML” property of a dynamic HTML (DHTML) element, using the browser's scripting language. Next, at a step 368, the logic returns to the main program or flowchart, which is shown in FIG. 13.

Although the present novel approach has been described in connection with the preferred form of practicing it and modifications thereto, those of ordinary skill in the art will understand that many other modifications can be made within the scope of the claims that follow. Accordingly, it is not intended that the scope of the present novel approach in any way be limited by the above description, but instead be determined entirely by reference to the claims that follow.

The invention in which an exclusive right is claimed is defined by the following:

1. A method for providing a form that is generated locally by a local runtime environment for display within a browser program, for interaction by a user, comprising the steps of:
(a) enabling the user to download the local runtime environment and a definition for the form over a network from a remote storage, wherein the local runtime environment is separate and distinct from an operating system in which the browser program is executed;
(b) based upon the definition that has been downloaded, within the local runtime environment, generating the form with one or more interface elements with which the user can interact;
(c) displaying the form within the browser program; and
(d) enabling the user to interact with the one or more interface elements of the form within the browser program, without requiring any interaction with a remote server, the user interaction including at least one of the following steps:
(i) making a selection within the form using an interface element;
(ii) carrying out a function by interacting with an interface element within the form;
(iii) entering data in connection with an interface element in the form; and
(iv) modifying the form.

2. The method of claim 1, wherein the step of modifying the form comprises the steps of:
(a) enabling the user to selectively enter a designer mode, to facilitate modifying the form; and
(b) enabling the user to select an option to modify one of a content and an appearance of the form after entering the designer mode.

3. The method of claim 2, wherein after entering the designer mode, further comprising the step of enabling the user to modify the form by at least one of:
(a) adding a new interface element comprising a control to the form;
(b) adding a new interface element comprising a menu to the form;
(c) adding a new interface element comprising an input dialog to the form;
(d) changing a size of an interface element in the form;
(e) changing a parameter affecting an appearance of one or more interface elements in the form; and
(f) associating a function with an interface element in the form.

4. The method of claim 3, further comprising the steps of:
(a) retaining information concerning changes made to the form to modify the definition, the information indicating any new elements that have been added to the form and any elements that have been deleted from the form; and
(b) uploading the definition with the changes made by the user to the remote storage so that the changes made by the user are indicated when the definition of the form is next downloaded.

5. The method of claim 3, further comprising the step of enabling the user to specify whether a new field added to the form by the user is private to the user or public and available to others who download the definition of the form as modified by the user.

6. The method of claim 5, further comprising the step of validating an identity of the user on a server coupled to the remote storage, to enable the user to download the definition for the form to which the user has been granted access rights.

7. The method of claim 1, wherein the step of enabling the user to download includes the step of enabling the user to select the definition of the form to be downloaded from a plurality of definitions of forms that are stored by a server in the remote storage.

8. The method of claim 1, further comprising the step of enabling the user to selectively download data for use with the form, over the network, from the remote site where the data are stored.

9. The method of claim 1, wherein the definition of the form is downloaded from the remote site over the network, in a format comprising one of the following:
(a) a JavaScript listing;
(b) extended markup language (XML); and
(c) a data structure that can undergo a reversible transformation into and out of a JavaScript listing.

10. The method of claim 9, wherein the JavaScript uses dynamic hypertext markup language (DHTML) for generating the form with one or more interface elements with which a user can interact.

11. The method of claim 9, wherein the local runtime environment is implemented using JavaScript.

12. The method of claim 1, further comprising the step of enabling the user to save the form after interacting with the form, by uploading a definition for the form and any data input by the user, to the remote storage, over the network.

13. The method of claim 1, wherein the one or more interface elements within the form include a control that is selectively actuatable by the user to initiate execution of a program module that carries out a function within the local runtime environment.

14. A memory medium on which are stored machine instructions, which when executed, are operative to carry out the steps of the method of claim 1.

15. A client system for providing a form that is generated locally by a local runtime environment for display within a browser program, for interaction by a user of the client system, comprising:
(a) a display;
(b) a user input device;
(c) a network interface device for coupling the system in communication with a server at a remote site, over a network;
(d) a memory for storing machine instructions, the machine instructions including instructions for executing the browser program; and
(e) a processor that is coupled to the display, the input device, the network interface, and the memory, the processor executing the machine instructions stored in the memory to carry out a plurality of functions, including:
(i) enabling a user to download a definition for the form and machine instructions over a network from a remote site, for executing the local runtime environment with the processor, wherein the local runtime environment is separate and distinct from an operating system in which the browser program is executed;
(ii) executing the local runtime environment and based upon the definition that has been downloaded, generating the form with one or more interface elements with which a user can interact;
(iii) rendering the form with the browser program on the display; and
(iv) enabling a user to interact with the one or more interface elements of the form within the browser program, without requiring any interaction with a remote server, a user interaction including at least one of:
(1) making a selection within the form using an interface element;
(2) carrying out a function by interacting with an interface element within the form;
(3) entering data in connection with an interface element in the form; and
(4) modifying the form.

16. The client system of claim 15, wherein the machine instructions for the local runtime environment, when executed by the processor, enable a user to modify the form by:
(a) selectively entering a designer mode to facilitate modifying the form; and
(b) enabling selection of an option to modify one of a content and an appearance of the form after the designer mode is entered.

17. The client system of claim 16, wherein after entry into the designer mode, the machine instructions for executing the local runtime environment enable the form to be modified by at least one of:
(a) adding a new interface element comprising a control to the form;
(b) adding a new interface element comprising a menu to the form;
(c) adding a new interface element comprising a text input dialog to the form;
(d) changing a size of an interface element in the form;
(e) changing a parameter affecting an appearance of one or more interface elements in the form; and
(f) associating a function with an interface element in the form.

18. The client system of claim 17, wherein the machine instructions comprising the local runtime environment further cause the processor to:
(a) retain information concerning changes made to the form to modify the definition, the information indicating any new elements that have been added to the form and any elements that have been deleted from the form; and
(b) upload the definition with the changes made to the remote storage so that the changes made are indicated when the definition of the form is next downloaded.

19. The client system of claim 17, wherein the local runtime environment enables specifying a new field that is added to the form as being private to a user that added the new field, or as public and available to others who download the definition of the form after the new field has been added.

20. The client system of claim 19, wherein the processor transmits a validation of an identify of a user of the client system to a server that is coupled in communication with the processor through the network interface, to enable the server to download the definition for the form to which the user has been granted access rights.

21. The client system of claim 15, wherein the browser program is employed to display a plurality of definitions from which the definition of the form to be downloaded is selectable, the plurality of definitions being stored in the remote storage by a server that is in communication with the processor over a network via the network interface.

22. The client system of claim 15, wherein the machine instructions comprising the local runtime environment enable selective download of data for use with the form, over the network, from the remote site where the data are stored.

23. The client system of claim 15, wherein the definition of the form is downloaded from the remote site over the network, in a format comprising one of the following:
(a) a JavaScript listing;
(b) extended markup language (XML) listing; and
(c) a data structure that can undergo a reversible transformation into and out of a JavaScript listing.

24. The client system of claim 23, wherein the JavaScript uses dynamic hypertext markup language (DHTML) for generating the form with one or more interface elements with which a user can interact.

25. The client system of claim 23, wherein the local runtime environment is implemented using JavaScript.

26. The client system of claim 15, wherein the local runtime environment enables the form to be saved after a user has interacted with the form, by uploading a definition for the form and any data input by the user, to the remote storage, over the network.

27. The client system of claim 15, wherein the one or more interface elements within the form include a control that is selectively actuatable by a user to initiate execution of a program module stored in the memory that carries out a function within the local runtime environment.
